(19) United States
(12) Patent Application Publication
(10) Pub. No.: US 2018/0025425 A1
(43) Pub. Date: Jan. 25, 2018

(54) METHOD AND SYSTEM FOR QUALIFYING USERS FOR AN ELECTRONIC TRADING ACCOUNT

(71) Applicant: TopstepTrader, LLC, Chicago, IL (US)

(72) Inventor: Michael Patak, Chicago, IL (US)

(21) Appl. No.: 15/655,706

(22) Filed: Jul. 20, 2017

Related U.S. Application Data
(60) Provisional application No. 62/365,138, filed on Jul. 21, 2016.

(51) Int. Cl. G06Q 40/04

(52) U.S. Cl. CPC G06Q 40/04

(57) ABSTRACT

A method according to one embodiment includes generating a real-time simulated trading account environment for interaction by a user, tracking the user's interaction with the real-time simulated trading account environment based on a first set of predefined parameters, determining whether the user's interaction satisfies a second predefined set of objectives while complying with the first set of predefined parameters over a first period of time, tracking, in response to determining that the user's interaction satisfies the second predefined set of objectives while complying with the first set of predefined parameters over the first period of time, the user's interaction with the real-time simulated trading account environment based on a second set of predefined parameters more restrictive than the first set of predefined parameters, and determining whether user's interaction satisfies a second predefined set of objectives while complying with the second set of predefined parameters over a second period of time.

### CROSS-REFERENCE TO RELATED APPLICATIONS

This application claims the benefit of U.S. Provisional Application Ser. No. 62/365,138 filed on Jul. 21, 2016, the contents of which are incorporated herein by reference in their entirety.

### FIELD

The present disclosure relates to a system and computer-implemented method to qualify users for an electronic trading account.

### BACKGROUND

Traditionally, if a user desires to trade on a financial instrument, the user takes the initiative of opening an account with a financial institution, such as a brokerage firm, and funds the account with an appropriate amount to cover trading activity and/or margin requirements. Typically, the steps involved in opening and funding an account with a trading firm include performing background and/or credit checks on the user and clearing funds transferred into the account by the user before allowing the user to place a trade.

These steps of developing a financial relationship between the user and financial institution have the purpose of reducing or eliminating the financial risk to the firm. The qualifications and/or abilities of the user to profit via trading are not considered or assessed. Because trading is funded by the user, there is no need to establish the qualifications or experience of the user because the firm benefits from the trade by charging fees based on the transaction and not upon whether profits are successfully generated.

Institutions also exist that profit from managing the money of clients such as, for example, individuals and/or other institutions. Those responsible for formulating and executing investment strategies and managing the portfolios of individuals and/or other institutions, e.g., via institutional trading, are required to be licensed investment professionals.

A more recent development includes entities that qualify and train traders. The traders, after some combination of successfully submitting entry fees and completing qualification modules, training modules, and trial periods, may be funded through the entity and potentially earn profits (for themselves and for the entity) by trading financial instruments. According to some of these models, the entity may assume risk by funding the qualified trader activity. Therefore, an objective of the entity is to minimize the risk by establishing some combination of controlled qualification methods, careful training and tracking, access to competent help resources, and strict or carefully formulated trading rules and limits.

### SUMMARY

In some embodiments, the present disclosure provides a performance-based assessment to qualify users for electronic trading. Further embodiments, forms, features, and aspects of the present application shall become apparent from the description and figures provided herewith.

### BRIEF DESCRIPTION OF THE DRAWINGS

The present disclosure will be described in even greater detail below based on the exemplary figures. The disclosure is not limited to the exemplary embodiments. Other features and advantages of various embodiments of the present disclosure will become apparent by reading the following detailed description with reference to the attached drawings which illustrate the following:

FIG. 1 is a simplified block diagram of at least one embodiment of a computer-implemented system to qualify a user for electronic trading;

FIG. 2 is a simplified flow diagram of at least one embodiment of a method for qualifying a user for electronic trading using the computer-implemented system of FIG. 1;

FIG. 3 is a simplified table identifying various parameters associated with at least one embodiment of the combine module;

FIG. 4 is a simplified table identifying various parameters associated with at least one embodiment of the training module; and

FIG. 5 is a simplified table identifying various parameters associated with at least one embodiment of a scaling plan.

### DETAILED DESCRIPTION

The present disclosure recognizes that it can be challenging, in particular, to eliminate risk with respect to electronic trading of financial instruments. An object of the disclosure is to provide a computer implemented system and methods to qualify a user for electronic trading to reduce risk to the operating entity, which may also be referred to herein as the “institution.”

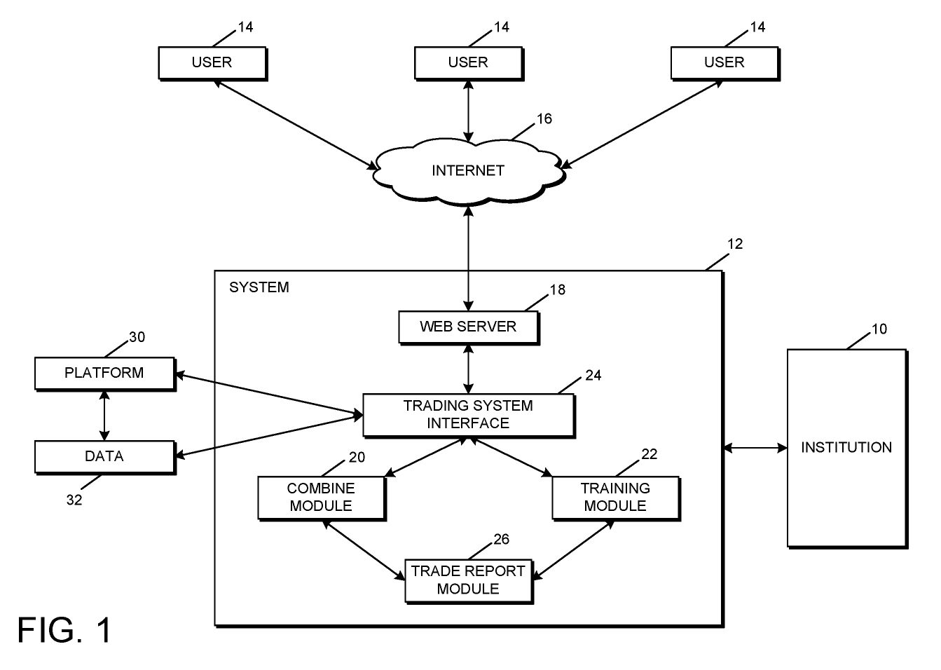

Referring now to FIG. 1, an illustrative embodiment of the system 12 is shown. It should be appreciated that the institution 10 may operate the system 12, and the system 12 may be accessed by one or more users 14. Further, the users 14 (e.g., individual clients) may access the system 12 through the internet 16 and/or via another suitable network. In the illustrative embodiment, the system 12 includes a combination of hardware, firmware, and/or software suitable for functioning as is described in detail herein to implement the various inventive concepts disclosed.

Users 14 may be potential clients that are engaging in research related to, for example, trading of financial instruments, the institution 10, and rules and procedures related to the disclosed system and methods. Users 14 may be potential clients that are being evaluated for consideration by the institution 10 by establishing an account. Users 14 may be clients who are engaging in qualification trials or training. Further, users 14 may be previously qualified clients, i.e., traders, who have successfully passed training and trials required by the institution 10 and have earned the funding for and the privilege of trading financial instruments through the system 12.

In the illustrative embodiment, the system 12 includes a web server 18. It should be appreciated that the web server 18 permits users 14 to access the functionality and resources offered by and through the institution 10. The web server 18 may also permit users 14 to navigate to sites not operated by the institution 10 and/or permit the institution to communicate with the users.

Each user 14 can access internal modules, trading applications and other sites, applications and/or functions of the system 12, including those operated by the institution 10 and/or applications, functions and sites operated independently of the institution. A “module” includes a computer-implemented system or sub-system with a predefined goal or an objective or a set of predefined goals or objectives that must be successfully met or exceeded by the user and the associated computer implemented software and computer hardware to enable operation of the system in executing toward completion of the goal(s). Meeting or exceeding the objective permits the user to proceed to the next module and/or grants the user a new set of permissions, activities or limits.

The internal modules of the system 12 include a combine module 20, a training module 22, and a trade report module 26. The combine module 20 is a real-time simulated trading account where a user's performance is evaluated for the opportunity to become a funded trader. The combine module 20 includes an objective that must be met or exceeded within a predefined time period and within a predefined set of parameters set by the institution 10 and rules established by the institution. The objective includes a profit target goal, which when met, permits the user to advance to the training module 22, which provides funded trader preparation and a simulated trading environment.

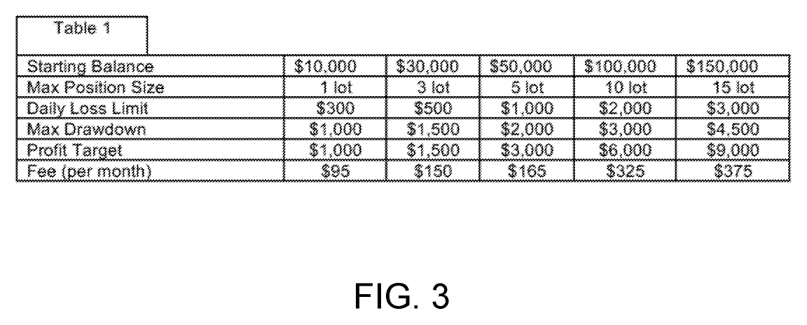

The combine module 20 may operate according to parameters set out in Table 1. To begin the qualifying process, a user 14, in other words a candidate for consideration for trading, applies for an account including the purchase of a subscription according to a predetermined amount of time, which permits the user to enter the combine module 20 by logging in, for example. The user 14 has as many days as is needed to reach the objective (see Table 1 of FIG. 3) with a minimum of ten days. The monthly cost to the user of using the combine module 20 is set to recur, for example, every 30 days from the sign up date. The user 14 operates in the combine module 20 until the objective is met or exceeded or the account is canceled.

The user 14 selects a starting balance from a plurality of balances. The starting balance is the initial amount of simulated funds in the user's trading combine account. Each of the plurality of starting balances has an associated maximum position size (the maximum position allowed or absolute value at any given time). For example, if the user 14 has a maximum position size of 3, he or she may be long 2 E-mini S&P and short 1 Crude Oil.

Each of the plurality of starting balances has an associated daily loss limit. The net profit and loss (P&L) cannot meet or exceed this amount in a trading day. The daily loss limit is factored based on each trading day's unrealized net P&L, which includes simulated commissions and fees and any unrealized trade value. For example, in a $150,000 combine module account, the daily loss limit is $3,000. Therefore, if at any point during the trading day the user's unrealized P&L hits or exceeds −$3,000, the daily loss limit is considered hit. At this time, at the discretion of a risk manager of the institution 10, any open trading positions may be flattened, i.e., liquidated.

Each of the plurality of starting balances has an associated maximum drawdown, defined as the account balance high minus maximum drawdown equals trailing maximum drawdown, which is calculated at the end of each trading day. The trailing maximum drawdown increases with each high water mark set in the user account. The trailing maximum drawdown will increase a defined distance as the account balance increases, and is calculated at the end of each trading day. If the user account balance decreases from the previous day, the trailing maximum drawdown does not change. Once the trailing maximum drawdown reaches the initial starting balance of the user account, it does not change for the remainder of the user's evaluation period. The trailing maximum drawdown will never be greater than the starting balance. In the illustrative embodiment, the starting balance of the account will either be $0, $30K, $50K, $100K or $150K. However, in other embodiments, it should be appreciated that the user may select from a different set of starting balances.

Each of the plurality of starting balances has an associated profit target, defined as the amount of net profit required to be considered for a funded trading account. The user 14 also is required to operate according to the following rules/objectives when using the combine module 20.

In the illustrative embodiment, the user 14 trades for a minimum of 10 days. Additionally, in some embodiments, the user 14 may only trade from a predetermined set of permitted products and times. For example, in some embodiments, the products may include CME Equity Futures including E-mini S&P 500 (ES), Nikkei NKD (NKD), E-mini NASDAQ 100 (NQ); CME Foreign Exchange Futures including Australian $ (6A), British Pound (6B), Canadian $ (6C), Euro FX (6E), Japanese Yen (6J), Swiss Franc (6S), E-mini Euro FX (E7); CME Agricultural Futures including Lean Hogs (HE), Live Cattle (LE); CME Interest Rate Futures including Eurodollar (GE); CME NYMEX Futures including Crude Oil (CL), E-mini Crude Oil (QM), Natural Gas (NG), E-mini Natural Gas (QG); CME CBOT Agricultural Futures including Corn (ZC), Wheat (ZW), Soybeans (ZS), Soybean Meal (ZM), Soybean Oil (ZL); CME CBOT Equity Futures including Mini-DOW (YM); CME CBOT Financial Futures including 2-Year Note (ZT), 5-Year Note (ZF), 10-Year Note (ZN), 30-Year Bond (ZB), Ultra-Bond (UB); CME COMEX Futures including Gold (GC). The permitted products and times are selected by the institution 10.

For example, in some embodiments, the rules require that trades occur during normal electronic trading hours unless otherwise indicated in the module and all positions must be closed by 3:10 PM CT or the market close of that product, whichever is sooner.

Additionally, in the illustrative embodiment, the user 14 must not hit or exceed the daily loss limit and the user 14 must not allow the account balance to hit or exceed the trailing maximum drawdown. In the illustrative embodiment, the user 14 must achieve an average net P&L greater than $0, which is evaluated at the end of the 10^{th} trading day.

In some embodiments, the user account may be reset at any time for a fee (e.g., $100). For example, the reset may be executed by clicking a virtual button on a trade report module 26 or some other aspect of the system 12. The reset reinitiates the starting balance and rules, but does not change the start date, i. e., the rebill date, which may be the due date of a monthly or 30 day, for example, periodic subscription payment calculated from the sign up date. The trade report module 26 may allow users to track their performance. For example, in some embodiments, the trade report module 26 may generate a report that includes various trading statistics and/or identifies areas of improvement for the user.

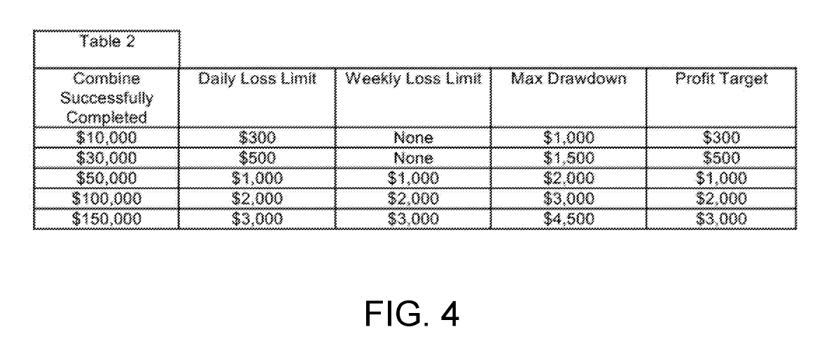

Upon successful completion of the combine module 20, the user 14 enters the training module 22, which is a funded trader preparation module. The training module 22 may operate according to parameters set out in Table 2 of FIG. 4.

According to the training module 22 rules, in some embodiments, the user 14 must trade the same product(s) that proved profitable in the combine module 20 and at the same simulated funding parameters with the same daily loss limit and max drawdown as successfully completed in the combine module 20. Further, the user 14 must trade during permitted times as noted above.

Additionally, in the illustrative embodiment, the user 14 must not hit or exceed the daily loss limit. Further, in the training module 22, the user 14 must also not hit or exceed a weekly lost limit. The weekly loss limit, following successful completion of a $50K, $100K or $150K combine module 20, is the maximum amount that the user may lose at any point in a calendar week (Monday through Friday). The weekly loss limit is factored based on the sum of the total net P&L realized in the calendar week (calculated intra-day). In some embodiments, the weekly loss limit rule is removed after the 10th trading day.

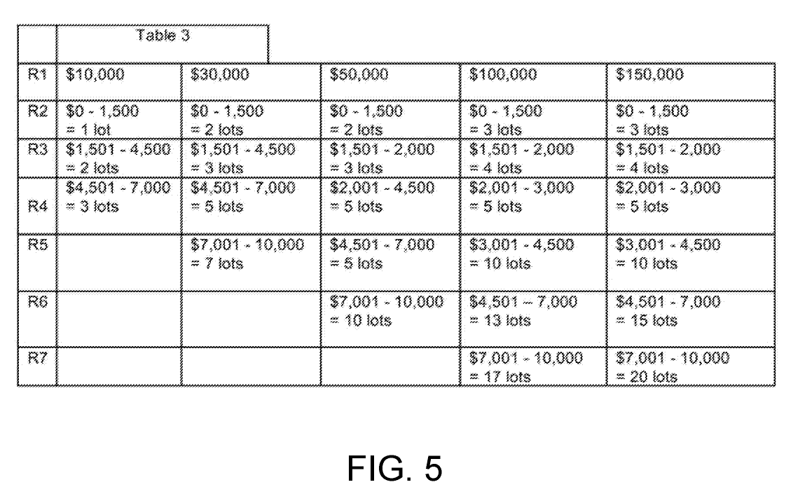

Further, in the illustrative training module 22, the user 14 must not allow the account balance to hit or exceed the trailing max drawdown as in the combine module 20. Additionally, in some embodiments, the user 14 must follow a scaling plan (see Table 3 of FIG. 5). The top row (R1) of Table 3 shows starting balances. The remaining rows (R2-7) of Table 3 show the net profit required above the balance required to trade the corresponding contract (number of lots).

Additionally, in some embodiments, the training module 22 requires that each user 14 must not hold positions into major economic releases, which include, for example, reports directed to Consumer Price Index, Durable Goods Orders, Employment Situation, Existing Home Sales, Fed Chair Press Conference FOMC Forecasts, FOMC Meeting Announcement, FOMC Minutes, GDP, Housing Starts, Industrial Production, International Trade, International Trade in Goods, ISM Mfg Index, Jobless Claims, New Home Sales, Personal Income and Outlays, Philadelphia Fed Business Outlook Survey, PPI-FD, Producer Price Index, and Retail Sales. Each module may include a listing of the major economic releases.

Further, in the illustrative embodiment, each user 14 must maintain an account balance greater than $0 after a minimum of 10 trading days to complete the training module 22.

During the combine module 20 and the training module 22, the users 14 may use a trading platform 30 selected from a pre-approved list of platforms. For example, the platforms may be selected from a group including NinjaTrader, T4, Sierra Chart, MarketDelta, Multicharts, R|Trader Pro, VolFix.NET, eSignal, Trade Navigator, and ATAS. The system 12 may have other functionality related to a Dashboard, billing, news, contact information and others. The particular platform 30 used is accessed through the trading system interface 24 of the system 12 and is therefore tracked by the system 12. The buy and sell data 32 is accessible to the platform and the interface 24.

When the user 14 meets the training module 22 objectives, funding may be authorized by the institution 10 and provided by an external funding source such that the user may begin trading.

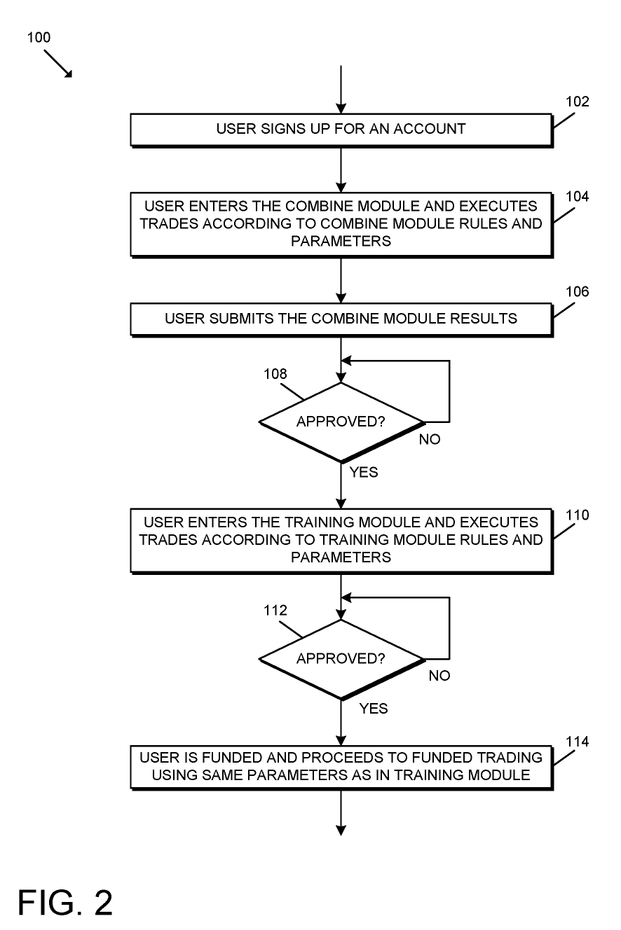

Referring now to FIG. 2, in use, the system 12 may execute a method 100 for qualifying a user for externally funded electronic trading. It should be appreciated that the particular blocks of the method 100 are illustrated by way of example, and such blocks may be combined or divided, added or removed, and/or reordered in whole or in part depending on the particular embodiment, unless stated to the contrary. The illustrative method 100 begins with block 102 in which a user 14 signs up for an account.

In block 104, the user 14 enters the combine module 20. As described above, the combine module is an evaluated, real-time, simulated trading account. The user's objective is to follow the above-detailed rules and meet the profit target. In block 106, the user 14 submits the combine module 20 results through the system 12 for review. If the results of the combine module 20 are approved in block 108 (i.e., the user 14 followed the rules required in the combine module 20 and met the relevant profit target and objectives), the method 100 advances to block 110 in which the user 14 enters the training module 22. As described above, in the illustrative embodiment, the training module 22 is the final step to become a funded trader. The training module 22 is a free, simulated account where the user/trader becomes accustomed to trading within the same parameters as will be required in the funded account. In the illustrative embodiment, if the combine module 20 results are not approved, the user 14 may continue to trade in the evaluated, real-time simulated trading account until the results are satisfactory.

If the results of the training module 22 are approved in block 112 (i.e., the user 14 has followed the rules required in the training module 22 and met the relevant profit target and objectives), the method 100 advances to block 114 in which the user is funded. In some embodiments, the funded user 14 may keep, for example, 100% of the first $5,000 net profit earned by trading, and 80% thereafter. Further, in some embodiments, the user 14 may withdraw funds at any time with no risk to personal capital. In the illustrative embodiment, if the training module 22 results are not approved, the user 14 may continue to trade in the free, simulated account until the results are satisfactory.

It should be appreciated that the system 12 and methods described herein may be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. Method steps can be performed by one or more processors executing a computer program to perform functions of the disclosure by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e. g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e. g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user 14, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e. g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system (e. g., a cloud-computing system) that includes any combination of such back-end, middleware, or front-end components. The above described techniques can be implemented as a Software-As-A-Service (SaaS) model or using a multi-tiered approach.

Communication networks can include one or more packet-based networks and/ or one or more circuit-based networks in any configuration. Packet-based networks can include, for example, an Ethernet-based network (e.g., traditional Ethernet as defined by the IEEE or Carrier Ethernet as defined by the Metro Ethernet Forum (MEF)), an ATM-based network, a carrier Internet Protocol (IP) network (LAN, WAN, or the like), a private IP network, an IP private branch exchange (IPBX), a wireless network (e.g., a Radio Access Network (RAN)), and/or other packet-based networks. Circuit-based networks can include, for example, the Public Switched Telephone Network (PSTN), a legacy private branch exchange (PBX), a wireless network (e.g., a RAN), and/ or other circuit-based networks. Carrier Ethernet can be used to provide point-to-point connectivity (e. g., new circuits and TDM replacement), point-to-multipoint (e. g., IPTV and content delivery), and/or multipoint-to-multipoint (e.g., Enterprise VPNs and Metro LANs). In some embodiments, carrier Ethernet may provide for a lower cost per megabit and more granular bandwidth options.

Devices of the computing system can include, for example, a computer, a computer with a browser device, a telephone, an IP phone, a mobile device (e. g., cellular phone, personal digital assistant (PDA) device, laptop computer, electronic mail device), and/or other communication devices. The browser device includes, for example, a computer (e.g., desktop computer, laptop computer, mobile device) with a world wide web browser (e.g., Microsoft® Internet Explorer® available from Microsoft Corporation, MoZilla® Firefox available from Mozilla Corporation).

While the disclosure has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present disclosure covers further embodiments with any combination of features from different embodiments described above and below. Additionally, statements made herein characterizing the disclosure refer to an embodiment of the disclosure and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A computing system, comprising:
a system interface to generate a real-time simulated trading account environment for interaction by a user;
a combine module to (i) track the user's interaction with the real-time simulated trading account environment based on a first set of predefined parameters and (ii) determine whether the user's interaction satisfies a second predefined set of one or more objectives while complying with the first set of predefined parameters over a first period of time; and
a training module to (i) track, in response to a determination that the user's interaction satisfies the second predefined set of one or more objectives while complying with the first set of predefined parameters over the first period of time, the user's interaction with the real-time simulated trading account environment based on a second set of predefined parameters more restrictive than the first set of predefined parameters and (ii) determine whether user's interaction satisfies a second predefined set of one or more objectives while complying with the second set of predefined parameters over a second period of time.

2. The computing system of claim 1, wherein the second set of predefined parameters comprises parameters associated with a funded, non-simulated trading account.

3. The computing system of claim 1, wherein the first set of predefined parameters comprises a starting account balance, a maximum position size, a daily loss limit, a maximum drawdown, a set of permitted trade times, and a profit target.

4. The computing system of claim 3, wherein the first set of one or more objectives comprises trading for at least a minimum trading period, maintaining daily losses below a daily loss limit, maintaining an account balance below a trailing maximum drawdown, and generating simulated earnings of at least the profit target.

5. The computing system of claim 4, wherein the minimum trading period is ten days.

6. The computing system of claim 4, wherein the second set of predefined parameters comprises the starting account balance, the maximum position size, the daily loss limit, the maximum drawdown, the set of permitted trade times, the profit target, and a weekly loss limit.

7. The computing system of claim 6, wherein the second set of one or more objectives comprises trading for at least the minimum trading period, maintaining daily losses below the daily loss limit, maintaining an account balance below the trailing maximum drawdown, generating simulated earnings of at least the profit target, and maintaining weekly losses below the weekly loss limit.

8. The computing system of claim 7, wherein the second set of one or more objectives further comprises following a scaling plan.

9. The computing system of claim 7, wherein the second set of one or more objectives further comprises remaining flat for one or more predefined major economic releases.

10. The computing system of claim 1, wherein the real-time simulated trading account environment comprises at least one of a NinjaTrader trading platform, a T4 trading platform, a Sierra Chart trading platform, a MarketDelta trading platform, a Multicharts trading platform, a R|Trader Pro trading platform, a VolFix.NET trading platform, a eSignal trading platform, a Trade Navigator trading platform, or a ATAS trading platform.

11. The computing system of claim 1, wherein the combine module permits the user to trade from a predetermined set of permitted products.

12. The computing system of claim 1, wherein each of the combine module and the training module is executed in a cloud-computing environment.

13. The computing system of claim 1, further comprising a trade report module to generate a report of the user's performance based on the user's interaction with the real-time simulated trading account environment.

14. A computing system, comprising:
at least one processor; and
at least one memory comprising a plurality of instructions stored thereon that, in response to execution by the at least one processor, causes the computing system to:
generate a real-time simulated trading account environment for interaction by a user;
track the user's interaction with the real-time simulated trading account environment based on a first set of predefined parameters;
determine whether the user's interaction satisfies a second predefined set of one or more objectives while complying with the first set of predefined parameters over a first period of time;
track, in response to a determination that the user's interaction satisfies the second predefined set of one or more objectives while complying with the first set of predefined parameters over the first period of time, the user's interaction with the real-time simulated trading account environment based on a second set of predefined parameters more restrictive than the first set of predefined parameters; and
determine whether user's interaction satisfies a second predefined set of one or more objectives while complying with the second set of predefined parameters over a second period of time.

15. The computing system of claim 14, wherein the second set of predefined parameters comprises parameters associated with a funded, non-simulated trading account.

16. The computing system of claim 14, wherein the first set of predefined parameters comprises a starting account balance, a maximum position size, a daily loss limit, a maximum drawdown, a set of permitted trade times, and a profit target.

17. The computing system of claim 16, wherein the first set of one or more objectives comprises trading for at least a minimum trading period, maintaining daily losses below a daily loss limit, maintaining an account balance below a trailing maximum drawdown, and generating simulated earnings of at least the profit target.

18. The computing system of claim 17, wherein the second set of predefined parameters comprises the starting account balance, the maximum position size, the daily loss limit, the maximum drawdown, the set of permitted trade times, the profit target, and a weekly loss limit.

19. The computing system of claim 18, wherein the second set of one or more objectives comprises trading for at least the minimum trading period, maintaining daily losses below the daily loss limit, maintaining an account balance below the trailing maximum drawdown, generating simulated earnings of at least the profit target, and maintaining weekly losses below the weekly loss limit.

20. A method, comprising:
generating, by a web server, a real-time simulated trading account environment for interaction by a user;
tracking, by the web server, the user's interaction with the real-time simulated trading account environment based on a first set of predefined parameters;
determining, by the web server, whether the user's interaction satisfies a second predefined set of one or more objectives while complying with the first set of predefined parameters over a first period of time;
tracking, by the web server and in response to determining that the user's interaction satisfies the second predefined set of one or more objectives while complying with the first set of predefined parameters over the first period of time, the user's interaction with the real-time simulated trading account environment based on a second set of predefined parameters more restrictive than the first set of predefined parameters; and
determining, by the web server, whether user's interaction satisfies a second predefined set of one or more objectives while complying with the second set of predefined parameters over a second period of time.
